(19) United States
(12) Patent Application Publication
(10) Pub. No.: US 2026/0311314 A1
(43) Pub. Date: Oct. 8, 2026

(54) IMAGE INSPECTION SYSTEM, IMAGE INSPECTION METHOD, AND PROGRAM

(71) Applicant: Sony Interactive Entertainment Inc., Tokyo (JP)

(72) Inventor: Shoichi Ikenoue, Chiba (JP)

(73) Assignee: Sony Interactive Entertainment Inc., Tokyo (JP)

(21) Appl. No.: 19/638,957

(22) Filed: Apr. 3, 2026

Related U.S. Application Data
(63) Continuation of application No. PCT/JP2024/035329, filed on Oct. 2, 2024.

(30) Foreign Application Priority Data
Oct. 10, 2023 (JP) 2023174934

(51) Int. Cl. G06T 7/00; G06T 7/11

(52) U.S. Cl. CPC G06T 7/0002; G06T 7/11; G06T 7/97; G06T 2207/10016; G06T 2207/20081

(57) ABSTRACT

To make it possible to easily check for an image defect in an estimated frame (24) output from a machine learning model (200). An image defect inspector (100) including at least one processor, wherein the at least one processor: acquires an n-th (where n is a natural number of 2 or greater) estimated frame (24) output from a machine learning model (200) by an n-th input frame (22) and (n−1)-th auxiliary information (28) related to features of first to (n−1)-th input frames (22) being input to the machine learning model (200); acquires a predetermined comparison target frame; detects a difference related to pixel information of the n-th estimated frame (24) with respect to the comparison target frame, based on the n-th estimated frame (24) and the comparison target frame; and acquires image defect information of the n-th estimated frame (24), based on the difference related to the pixel information.

### TECHNICAL FIELD

The present disclosure relates to an image inspection system, an image inspection method, and a program.

### BACKGROUND ART

A technique of estimating a still image having high image quality based on a still image having low image quality using a machine learning model (super-resolution) is conventionally known (see NPL 1 below).

### CITATION LIST

### Non Patent Literature

NPL 1: Chao Dong, Chen Change Loy, Kaiming He, Xiaoou Tang. Learning a Deep Convolutional Network for Image Super-Resolution, in Proceedings of European Conference on Computer Vision (ECCV), 2014

### SUMMARY

### Technical Problem

The inventors of the present application have studied the use of a machine learning model having a recursive configuration that uses information of past frames, in order to implement video super-resolution such as in a game screen. In such a configuration using the information of past frames as described above, an image defect may occur in an estimated frame output from the machine learning model. Although it is possible to visually check whether an image defect has occurred, this requires human labor and may cause oversights.

The present disclosure has an object to provide an image inspection system, an image inspection method, and a program that make it possible to easily check for an image defect in an estimated frame output from a machine learning model.

### Solution to Problem

An image inspection system according to the present disclosure is an image inspection system including at least one processor, wherein the at least one processor: acquires an n-th (where n is a natural number of 2 or greater) estimated frame output from a machine learning model by an n-th input frame and (n−1)-th auxiliary information related to features of first to (n−1)-th input frames being input to the machine learning model; acquires a predetermined comparison target frame; detects a difference related to pixel information of the n-th estimated frame with respect to the comparison target frame, based on the n-th estimated frame and the comparison target frame; and acquires image defect information of the n-th estimated frame, based on the difference related to the pixel information.

### BRIEF DESCRIPTION OF DRAWINGS

FIG. 1 is a diagram illustrating an example of a hardware configuration of an image processing system and an image defect detector.

FIG. 2 is a diagram illustrating an overview of the image processing system.

FIG. 3 is a diagram schematically illustrating processing of the image processing system.

FIG. 4 is a functional block diagram illustrating an example of functions implemented in the image processing system.

FIG. 5 is a diagram for describing processing of a rendering unit.

FIG. 6 is a diagram for describing processing in an input frame acquisition unit.

FIG. 7 is a diagram for describing an overview of the image defect detector.

FIG. 8 is a functional block diagram illustrating an example of functions implemented in the image defect detector.

FIG. 9A is a flowchart illustrating an example of a flow of processing executed by the image processing system.

FIG. 9B is a flowchart illustrating an example of a flow of processing executed by the image processing system.

FIG. 10 is a flowchart illustrating an example of a flow of processing executed by an image defect detector.

### DESCRIPTION OF EMBODIMENTS

An example of an embodiment of an image processing system according to the present disclosure will be described below with reference to the drawings.

### 1. Hardware Configuration of Image Processing System

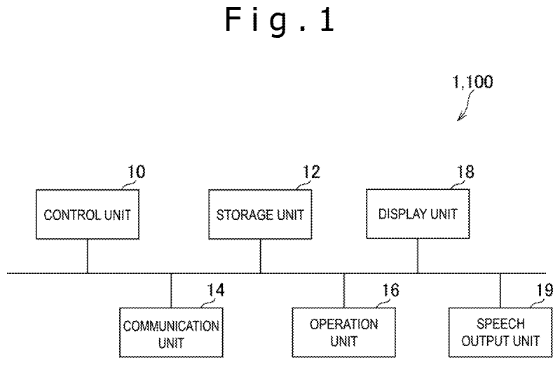

An image processing system 1 is a computer such as a game console (game machine), for example. As illustrated in FIG. 1, the image processing system 1 includes a control unit 10, a storage unit 12, a communication unit 14, an operation unit 16, a display unit 18, and a speech output unit 19.

The control unit 10 includes a program control device such as a CPU that operates in accordance with a program installed in the image processing system 1, for example. The control unit 10 also includes a graphics processing unit (GPU) that renders an image in a frame buffer, based on a graphics command, data, and the like supplied from the CPU.

The storage unit 12 includes a main storage device such as a ROM and a RAM, and an auxiliary storage device such as an HDD and an SSD, for example. The storage unit 12 stores a program or the like to be executed by the control unit 10. For example, the storage unit 12 stores a game program (game software), in addition to the program for implementing various functions of the image processing system 1 to be described below. A region of the frame buffer in which the image is rendered by the GPU is allocated in the storage unit 12.

The communication unit 14 is a communication interface such as an Ethernet (trade name) module or a wireless LAN module, for example.

The operation unit 16 is a user interface such as a keyboard, a mouse, or a controller of the game console, accepts an operation input from a user, and outputs a signal indicating a content thereof to the control unit 10.

The display unit 18 is a display device such as a liquid crystal display or an organic EL display, and displays various images in accordance with an instruction from the control unit 10.

The speech output unit 19 is a speaker or the like, for example, and outputs speech indicated by speech data generated by the image processing system 1.

Note that the image processing system 1 may include an optical disc drive that reads an optical disc such as a DVD-ROM or a Blu-ray (trade name) disc, a universal serial bus (USB) port, or the like, in addition to the devices described above.

### 2. Overview of Image Processing System

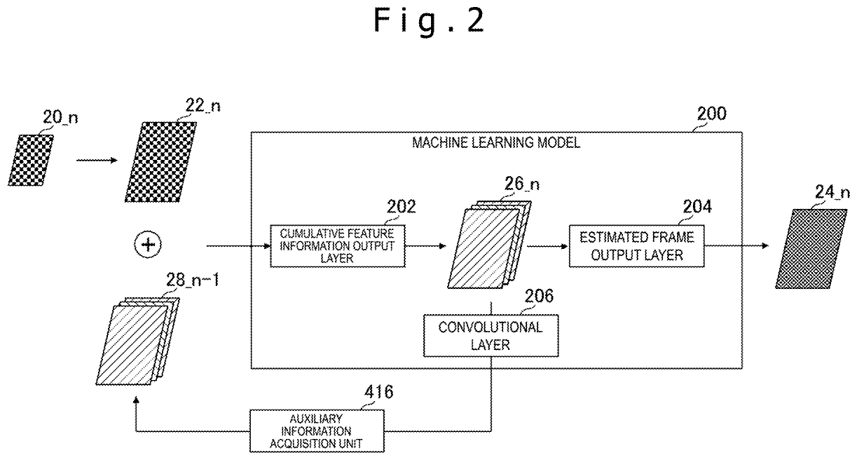

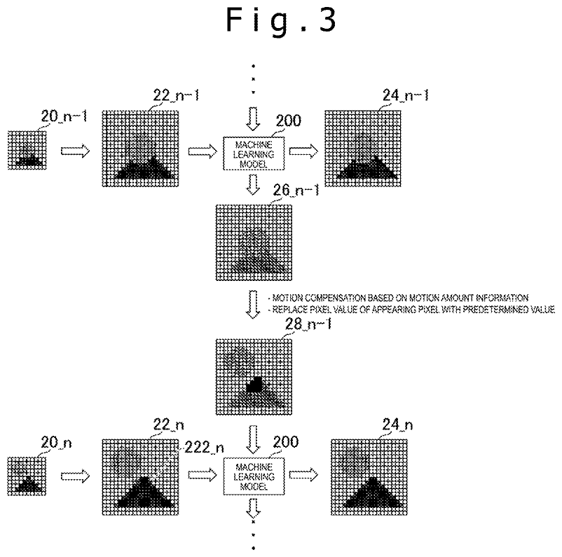

FIG. 2 is a diagram illustrating an overview of the image processing system 1. FIG. 3 is a diagram schematically illustrating processing of the image processing system 1. The present embodiment illustrates a case in which the image processing system 1 is used for enhancement of image quality of a gameplay video in a game. The gameplay video is a video generated in accordance with a game program executed by the control unit 10, an input from the user accepted by the operation unit 16, or the like, and includes a plurality of still images (frames) being time-series data. The processing performed by the image processing system 1 is mainly as follows.

### (1) Generation of Processing Target Frame

By executing rendering of three-dimensional data indicating one or more game objects seen from a predetermined perspective, the image processing system 1 generates an image (processing target frame) in which the game object(s) are rendered. The processing target frame is an image having a predetermined number of pixels (number of initial pixels) and predetermined image quality (initial image quality) (see FIG. 3). The processing target frame is generated at predetermined time intervals. The number of pixels of the processing target frame is 1920×1080 (1080p), for example. Each generated processing target frame is not directly displayed on the display unit 18 but is first stored in the storage unit 12 and provided for subsequent processing. Note that although the following description mainly illustrates processing targeting an n-th (2≤n≤N; where n and N are natural numbers of 2 or greater) processing target frame 20_n, similar processing is also executed on other processing target frames (i.e., n=2, 3, . . . , N).

### (2) Acquisition of Input Frame

The image processing system 1 acquires a frame (input frame) 22_n having a number of pixels (number of input pixels) greater than the number of initial pixels, based on the acquired processing target frame 20_n. The number of input pixels is 3840×2160 (4K), for example. Specifically, the input frame 22_n is generated by executing enlargement and interpolation processing on the processing target frame 20_n (see FIG. 3).

Here, it should be noted that although the input frame 22_n has a number of pixels greater than the number of pixels of the processing target frame 20_n, the image quality thereof is not necessarily sufficiently improved. In other words, the image quality of a frame does not simply refer to how much the number of pixels is (how high the resolution is). The image quality of a frame may be evaluated based on each of or a comprehensive consideration of how high an SN ratio is, how high reproducibility of a spatial frequency is, how high temporal stability is (how few artifacts or how little flickering is present in continuous display of a plurality of frames), and the like, when compared to a reference frame, for example.

### (3) Acquisition of Estimated Frame

The image processing system 1 inputs the input frame 22_n to a machine learning model 200, and acquires an estimated frame 24_n. The estimated frame 24_n is an image having a number of pixels (number of estimated pixels) equal to the number of input pixels and image quality (estimated image quality) being image quality equal to or higher than the initial image quality (see FIG. 3).

Here, (n−1)-th auxiliary information 28_n−1 is input to the machine learning model 200, in addition to the input frame 22_n (see FIGS. 2 and 3). The auxiliary information 28_n−1 is information based on (n−1)-th cumulative feature information 26_n−1 indicating features of first to (n−1)-th input frames 22. Details of cumulative feature information 26 and auxiliary information 28 will be described below.

### (4) Acquisition of Cumulative Feature Information

The machine learning model 200 includes a cumulative feature information output layer 202 to which the input frame 22_n and the auxiliary information 28_n−1 are input, and that outputs n-th cumulative feature information 26_n indicating features of the first to n-th input frames 22 (see FIG. 2). The image processing system 1 acquires the n-th cumulative feature information 26_n.

The acquired n-th cumulative feature information 26_n is input to an estimated frame output layer 204, and the n-th estimated frame 24_n is output from the estimated frame output layer 204 (see FIG. 2). Note that the acquired n-th cumulative feature information 26 n is also stored in the storage unit 12, and is provided for estimation of an estimated frame 24_n+1 corresponding to a subsequent processing target frame ((n+1)-th processing target frame) 20_n+1.

### (5) Acquisition of Auxiliary Information

As described above, the (n−1)-th cumulative feature information 26_n−1 is information indicating features of the first to (n−1)-th input frames 22 (or first to (n−1)-th processing target frames 20). By using the cumulative feature information 26_n−1, in which information of past processing target frames 20 is accumulated, for estimation of the n-th estimated frame 24_n as described above, information available for estimation increases, and thus the estimated frame 24_n having high image quality can be obtained.

However, when motion of the displayed game object or the like is present between the (n−1)-th processing target frame 20_n−1 and the n-th processing target frame 20_n, and the n-th input frame 22_n and the cumulative feature information 26_n−1 are directly input to the machine learning model 200, a phenomenon (so-called ghost phenomenon) may occur in which an afterimage of the game object displayed in the (n−1)-th processing target frame 20_n−1 is displayed.

In view of this, by applying various corrections described below based on information (a motion vector, a depth buffer, or the like) obtained at the time of rendering to the cumulative feature information 26_n−1, the image processing system 1 acquires the (n−1)-th auxiliary information 28_n−1 (see FIGS. 2 and 3). As described above, the acquired (n−1)-th auxiliary information 28_n−1 is input to the machine learning model 200 together with the n-th input frame 22_n, and is provided for estimation of the n-th estimated frame 24 n.

As described above, in the image processing system 1 according to the present embodiment, an estimated frame 24 is estimated using the auxiliary information 28 in which past information is accumulated, in addition to the input frame 22 corresponding to the current processing target frame 20. Consequently, information available for estimation increases, and thus the estimated frame 24_n having high image quality can be obtained.

### 3. Functions Implemented in Image Processing System

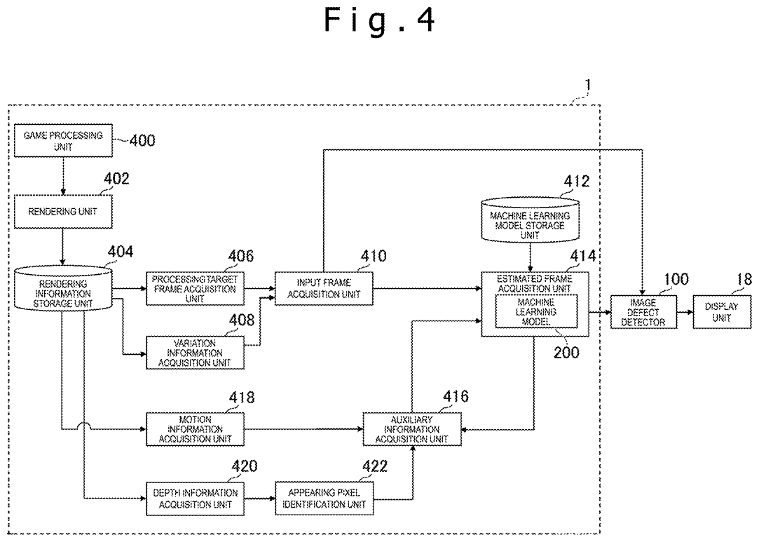

FIG. 4 is a functional block diagram illustrating an example of functions implemented in the image processing system 1. As illustrated in FIG. 4, in the image processing system 1, a game processing unit 400, a rendering unit 402, a rendering information storage unit 404, a processing target frame acquisition unit 406, a variation information acquisition unit 408, an input frame acquisition unit 410, a machine learning model storage unit 412, an estimated frame acquisition unit 414, an auxiliary information acquisition unit 416, a motion information acquisition unit 418, a depth information acquisition unit 420, and an appearing pixel identification unit 422 are implemented.

The game processing unit 400, the rendering unit 402, the processing target frame acquisition unit 406, the variation information acquisition unit 408, the input frame acquisition unit 410, the estimated frame acquisition unit 414, the auxiliary information acquisition unit 416, the motion information acquisition unit 418, the depth information acquisition unit 420, and the appearing pixel identification unit 422 are mainly implemented by the control unit 10. The rendering information storage unit 404 and the machine learning model storage unit 412 are mainly implemented by the storage unit 12. Note that the game processing unit 400, the rendering unit 402, and the rendering information storage unit 404 are functions provided by the game software.

### Game Processing Unit

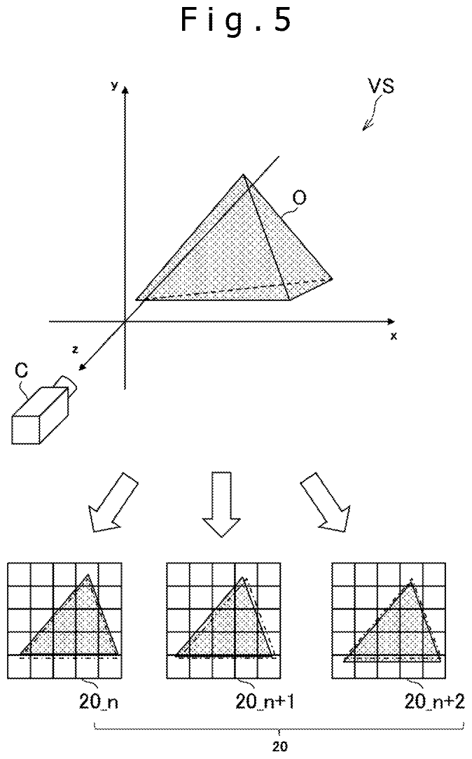

The game processing unit 400 executes various processing related to the game. The game processing unit 400 executes processing of arranging a game object O in a virtual three-dimensional space VS, processing of causing the game object O to operate or move, processing of changing a perspective C from which the virtual three-dimensional space VS is seen, or the like in accordance with a game program executed by the control unit 10 and an input from the user accepted by the operation unit 16, for example (see FIG. 5). The game object O is made of primitives such as polygons indicated by three-dimensional data. The three-dimensional data includes geometric information indicating positions such as vertices, phase information indicating how the vertices are connected, and attribute information such as colors.

### Rendering Unit

FIG. 5 is a diagram for describing processing of the rendering unit 402. By executing rendering (rendering processing) of the three-dimensional data indicating one or more game objects O seen from the predetermined perspective C, the rendering unit 402 generates the first to N-th (where N is a natural number of 2 or greater) processing target frames 20. The rendering unit 402 executes the rendering, based on results of various processing executed in the game processing unit 400. Specifically, the rendering unit 402 executes vertex processing (vertex shading) and pixel processing (pixel shading), based on the three-dimensional data indicating the game object(s) O arranged in the virtual three-dimensional space VS. The vertex processing includes coordinate conversion processing (perspective projection) from a view coordinate system to a screen coordinate system, and a numerical value related to variation of the perspective C is added to a perspective projection matrix (camera matrix) used in the coordinate conversion processing as will be described below. The rendering unit 402 may execute the rendering, based on light source information, depth information (depth buffer), texture information, normal information, and the like.

Here, the rendering unit 402 generates each processing target frame 20 by executing the rendering so that the perspective C varies for each processing target frame 20. Here, even when the game processing unit 400 fixes the perspective C at a predetermined position, the rendering unit 402 adds variation to the perspective C for each processing target frame 20. As a result, as illustrated in FIG. 5, the position of the displayed game object O varies in each of the processing target frames 20_n, 20_n+1, and 20_n+2. In other words, the rendering unit 402 applies jitter when generating each processing target frame 20. Specifically, by adding a numerical value corresponding to a size smaller than one pixel being different for each processing target frame 20 to the perspective projection matrix, the rendering unit 402 varies the perspective C for each processing target frame 20. The rendering unit 402 varies the perspective C for each processing target frame 20 in accordance with a predetermined rule. As such a rule, a Halton sequence can be used, for example.

### Rendering Information Storage Unit

The rendering information storage unit 404 stores information necessary for rendering processing in the rendering unit 402 and information obtained as a result of the rendering processing. For example, the rendering information storage unit 404 stores the processing target frame 20. The rendering information storage unit 404 stores the variation information, the motion information, and the depth information. Details of the variation information, the motion information, and the depth information will be described below. In addition, the rendering information storage unit 404 may store parameters used for coordinate conversion, the light source information, the texture information, the normal information, and the like.

### Processing Target Frame Acquisition Unit

The processing target frame acquisition unit 406 acquires each of the first to N-th processing target frames 20. Specifically, the processing target frame acquisition unit 406 acquires each of the first to N-th processing target frames 20 stored in the rendering information storage unit 404.

### Variation Information Acquisition Unit

The variation information acquisition unit 408 acquires the variation information. The variation information acquisition unit 408 acquires the variation information stored in the rendering information storage unit 404. Specifically, the variation information is information indicating a variation amount of the perspective C from before the variation to after the variation. It can also be said that the information indicating the variation amount is a variation vector indicating a direction and a distance of the variation. For example, the Halton sequence described above includes the information indicating the variation amount of the perspective C, and thus the information may be used as the variation information.

### Input Frame Acquisition Unit

The input frame acquisition unit 410 acquires each of the first to N-th input frames 22, by generating the input frame 22 corresponding to the processing target frame 20 and having a number of input pixels equal to or greater than the number of initial pixels, based on each processing target frame 20. In the present embodiment, each input frame 22 has a number of input pixels greater than the number of initial pixels. In other words, in the present embodiment, each input frame 22 is an image obtained by enlarging the processing target frame 20 corresponding to the input frame 22.

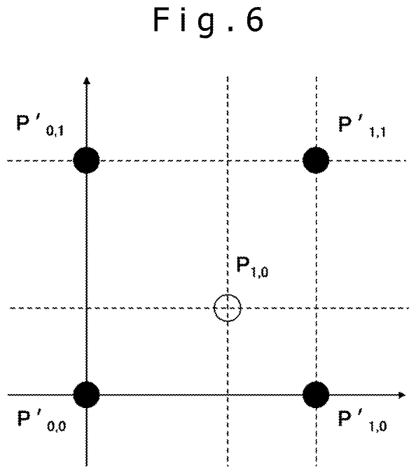

Specifically, the input frame acquisition unit 410 obtains a pixel value of a position corresponding to each pixel before the variation in the processing target frame 20 by interpolation based on the variation information and each pixel of each processing target frame 20, and generates each input frame 22. FIG. 6 is a diagram for describing processing in the input frame acquisition unit 410. FIG. 6 illustrates a case of obtaining the n-th input frame 22_n. For example, as illustrated in FIG. 6, when a pixel center of a certain pixel in the input frame 22_n to be acquired is represented by P1,0, the input frame acquisition unit 410 obtains a pixel value of P_{1,0} by bilinear interpolation, based on coordinates and pixel values of respective pixel centers P′_{0,0}, P′_{1,0}, P′_{0,1}, and P′_{1,1} of four pixels that are closest to P_{1,0} in the processing target frame 20_n. Here, P′_{1,0} is located at a position shifted from P_{1,0} by the variation amount indicated by the variation information. Pixel values of pixels newly generated in enlarging processing are also similarly obtained. Note that various known methods, such as bicubic interpolation and Lanczos interpolation, can be used as the interpolation method, in addition to bilinear interpolation.

While the amount of time-series information increases when rendering is executed so that the perspective C varies for each processing target frame 20, the estimated frame 24 having higher image quality can be obtained by using each processing target frame 20 (hereinafter referred to as “variation processing target frame”) obtained in this manner for estimation.

On the other hand, when the variation processing target frame (or an image obtained by enlarging this) is directly input to the machine learning model 200, accuracy of estimation may decrease due to the influence of the variation of the perspective C.

In view of this, as described above, in the image processing system 1, based on the variation information and each pixel of each processing target frame 20, the pixel value of the position corresponding to each pixel before the variation in the processing target frame 20 is obtained by interpolation, and each input frame 22 is generated and input to the machine learning model 200. Consequently, the influence of the variation of the perspective C is corrected, and thus the decrease in accuracy of estimation can be reduced.

### Machine Learning Model

The machine learning model 200 is a model that estimates the n-th estimated frame 24_n, based on the n-th input frame 22_n. Specifically, the machine learning model 200 is a model that estimates the n-th estimated frame 24_n, based on the n-th input frame 22_n and the (n−1)-th auxiliary information 28_n−1. Specifically, the machine learning model 200 is a convolutional neural network (CNN). For example, a known model such as ResNet with a multilayer structure having a residual connection mechanism or a so-called encoder-decoder U-Net can be used as the machine learning model 200. The model described in NPL 1 may be used as the machine learning model 200.

The machine learning model 200 is a model that is trained using a plurality of pieces of training data, each of which includes each of a training input frame having the number of input pixels and a training estimated frame having the number of estimated pixels. Various known methods, such as backpropagation, can be used for the training of the machine learning model 200.

Specifically, the machine learning model 200 includes the cumulative feature information output layer 202, the estimated frame output layer 204, and a convolutional layer 206 (see FIG. 2).

The n-th input frame 22_n and the (n−1)-th auxiliary information 28_n−1 based on the (n−1)-th cumulative feature information 26_n−1 indicating features of the first to (n−1)-th input frames 22 are input to the cumulative feature information output layer 202, and the cumulative feature information output layer 202 outputs the n-th cumulative feature information 26_n indicating features of the first to n-th input frames 22_n. The cumulative feature information output layer 202 may include one or more convolutional layers, for example. The cumulative feature information 26_n−1 is image information (information in bitmap format) having a number of pixels equal to the number of input pixels. It can also be said that the cumulative feature information 26_n−1 is a feature map indicating the features of the first to (n−1)-th input frames 22.

Note that a first input frame 22_1 and given auxiliary information are input to the cumulative feature information output layer 202, and the cumulative feature information output layer 202 outputs the first cumulative feature information 26_1. When n=1, the given auxiliary information prepared in advance is input to the cumulative feature information output layer 202 together with the first input frame 22_1, because no previous cumulative feature information 26 or auxiliary information 28 exists.

The n-th cumulative feature information 26_n is input to the estimated frame output layer 204, and the estimated frame output layer 204 outputs the n-th estimated frame 24_n. Similarly to the cumulative feature information output layer 202, the estimated frame output layer 204 may include one or more convolutional layers, for example. Alternatively, the estimated frame output layer 204 may include one or more transposed convolutional layers (deconvolutional layers).

The convolutional layer 206 is a layer that maintains the number of pixels of the cumulative feature information 26 and reduces the number of channels thereof. The cumulative feature information 26 output from the convolutional layer 206 is provided for processing in the auxiliary information acquisition unit 416. According to the convolutional layer 206, dimensions of the cumulative feature information 26 are reduced, and thus calculation cost can be reduced. For example, the convolutional layer 206 is a convolutional layer having a kernel size of 1×1, but is not limited thereto.

### Machine Learning Model Storage Unit

The machine learning model storage unit 412 stores the machine learning model 200. Specifically, the machine learning model storage unit 412 stores parameters (the number of convolutional layers, the number of nodes used for each convolutional layer, the weight of each node, and the like) of the machine learning model 200.

### Estimated Frame Acquisition Unit

The estimated frame acquisition unit 414 inputs each input frame 22 to the machine learning model 200, and acquires each of the first to N-th estimated frames 24 having a number of estimated pixels greater than the number of initial pixels and equal to or greater than the number of input pixels. In the present embodiment, the estimated frame 24 has a number of estimated pixels equal to the number of input pixels. More specifically, the estimated frame acquisition unit 414 inputs the n-th input frame 22_n and the (n−1)-th auxiliary information 28_n−1 to the machine learning model 200, and acquires the n-th estimated frame 24_n.

### Motion Information Acquisition Unit

The motion information acquisition unit 418 acquires the (n−1)-th motion information being information indicating the amount and the direction of motion from the (n−1)-th processing target frame 20_n−1 to the n-th processing target frame 20_n. Specifically, the (n−1)-th motion information is image information (information in bitmap format) having a number of pixels equal to the number of input pixels and indicating the amount and the direction of motion of each pixel between the (n−1)-th processing target frame 20_n−1 and the n-th processing target frame 20_n. The motion information is also referred to as a motion vector. Specifically, by acquiring original motion information having a number of pixels equal to the number of initial pixels and executing the enlargement and interpolation processing on the original motion information, the motion information acquisition unit 418 acquires the motion information having a number of pixels equal to the number of input pixels.

### Depth Information Acquisition Unit

The depth information acquisition unit 420 acquires the (n−1)-th depth information indicating the depth of each pixel of the (n−1)-th processing target frame 20_n−1 and the n-th depth information indicating the depth of each pixel of the n-th processing target frame 20_n. Specifically, the depth information is image information (information in bitmap format) having a number of pixels equal to the number of input pixels. The depth information is also referred to as a depth buffer or a Z-buffer. Specifically, by acquiring original depth information having a number of pixels equal to the number of initial pixels and executing the enlargement and interpolation processing on the original depth information, the depth information acquisition unit 420 acquires the depth information having a number of pixels equal to the number of input pixels.

### Appearing Pixel Identification Unit

The appearing pixel identification unit 422 identifies, among the pixels of the n-th input frame 22_n, an n-th appearing pixel 222_n being a pixel in which the entire or a part of the game object O not displayed in the (n−1)-th input frame 22_n−1 is displayed, based on the (n−1)-th depth information and the n-th depth information (see FIG. 3). Specifically, the appearing pixel identification unit 422 identifies the n-th appearing pixel 222_n, based on a difference between the (n−1)-th depth information and the n-th depth information. Note that the appearing pixel identification unit 422 may identify the n-th appearing pixel 222_n, based on an (n−1)-th perspective projection matrix related to the (n−1)-th input frame 22_n−1 and an n-th perspective projection matrix related to the n-th input frame 22_n. The appearing pixel identification unit 422 may identify the n-th appearing pixel 222_n by using the (n−1)-th motion information. Note that, more specifically, the appearing pixel identification unit 422 identifies the n-th appearing pixel, and generates n-th appearing pixel information being the image information indicating the position of the n-th appearing pixel 222_n.

### Auxiliary Information Acquisition Unit

The auxiliary information acquisition unit 416 acquires the (n−1)-th auxiliary information 28_n−1 so that motion compensation is applied to the (n−1)-th cumulative feature information 26_n−1, based on the (n−1)-th motion information. The motion compensation refers to processing of, when a pixel located at position x in the (n−1)-th input frame 22_n−1 is moved to position x′ in the n-th input frame 22_n, moving the pixel at the position x of the (n−1)-th cumulative feature information 26_n−1 to the position x′, for example (see FIG. 5). In other words, the auxiliary information acquisition unit 416 acquires the (n−1)-th auxiliary information 28_n−1 so that each pixel value of one or more pixels of the (n−1)-th cumulative feature information 26_n−1 is set to the pixel at the position moved according to the amount and the direction of motion of the pixel, based on the (n−1)-th motion information.

When the n-th estimated frame 24_n is acquired in a case where motion of the game object O is present between the n-th processing target frame 20_n and the (n−1)-th processing target frame 20_n−1, direct input of the n-th input frame 22_n and the (n−1)-th cumulative feature information 26_n−1 to the machine learning model 200 may cause a ghosting phenomenon in which an afterimage of the game object O displayed in the n-th input frame 22_n is displayed in the output n-th estimated frame 24_n.

In view of this, as described above, in the image processing system 1, the (n−1)-th auxiliary information 28_n−1 is acquired so that motion compensation is applied to the (n−1)-th cumulative feature information 26_n−1, based on the (n−1)-th motion information, and when the n-th estimated frame 24_n is acquired, the (n−1)-th auxiliary information 28_n−1 is input to the machine learning model 200. Consequently, the ghosting phenomenon can be reduced.

### 4. Image Defect Detector

As illustrated in FIG. 1, an image defect detector 100 may have a hardware configuration similar to the image processing system 1. In other words, the image defect detector 100 may include the control unit 10, the storage unit 12, the communication unit 14, the operation unit 16, the display unit 18, and the speech output unit 19. Note that each of these units may be partially common to each unit included in the image processing system 1. In the present embodiment, an example of one image defect detector is described as an example of the image inspection system; however, the present embodiment is not limited thereto, and the image inspection system may include a plurality of computers.

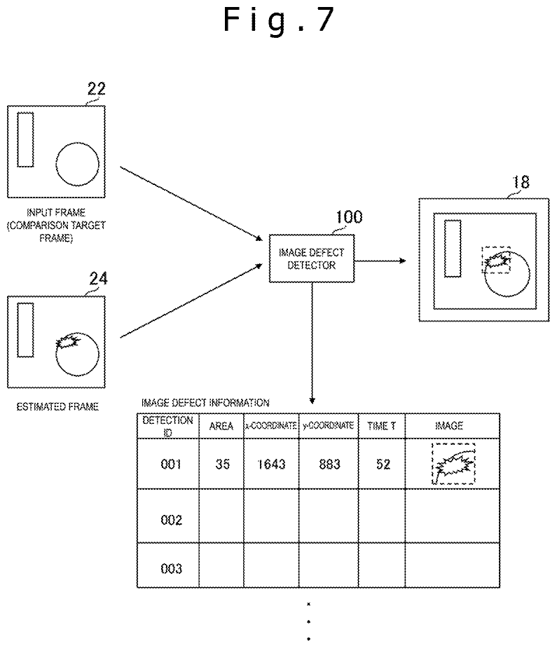

FIG. 7 is a diagram for describing an overview of the image defect detector. The image defect detector 100 is a computer in which a program for creating a game program is installed, for example. The estimated frame 24 generated in the image processing system 1 and a comparison target frame are input to the image defect detector 100. FIG. 7 illustrates an example of a case in which the input frame 22 is used as the comparison target frame.

The image defect detector 100 detects a difference related to pixel information of the estimated frame 24 with respect to the input frame 22 based on the estimated frame 24 and the input frame 22 being the comparison target frame, and acquires image defect information in the estimated frame 24 based on the detected difference related to the pixel information. Here, the pixel information refers to luminance, contrast, structure, and the like in one or more pixels. The functions of the image defect detector 100 will be described below in detail.

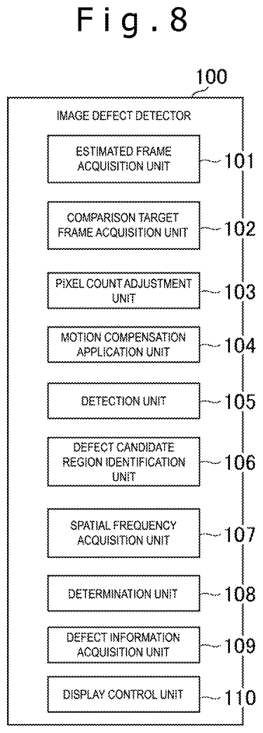

FIG. 8 is a functional block diagram illustrating an example of functions implemented in the image defect detector 100. As illustrated in FIG. 8, an estimated frame acquisition unit 101, a comparison target frame acquisition unit 102, a pixel count adjustment unit 103, a motion compensation application unit 104, a detection unit 105, a defect candidate region identification unit 106, a spatial frequency acquisition unit 107, a determination unit 108, a defect information acquisition unit 109, and a display control unit 110 are implemented in the image defect detector 100. Each of these units is mainly implemented by the control unit 10. Note that, as will be described below, the pixel count adjustment unit 103 and the motion compensation application unit 104 need not be provided depending on the number of pixels and the time (frame number) of the comparison target frame to be used.

### Estimated Frame Acquisition Unit

The estimated frame acquisition unit 101 acquires the n-th estimated frame 24_n generated in the image processing system 1.

### Comparison Target Frame Acquisition Unit

The comparison target frame acquisition unit 102 acquires the comparison target frame. In the present embodiment, the n-th input frame 22_n being the comparison target frame may be acquired. Note that this is not restrictive, and the comparison target frame acquisition unit 102 may acquire an (n−1)-th estimated frame 24_n−1 or the training estimated frame as the comparison target frame.

### Pixel Count Adjustment Unit

The pixel count adjustment unit 103 adjusts the number of pixels of the comparison target frame so that the n-th estimated frame 24_n and the comparison target frame have the same number of pixels. For example, when the number of pixels of the n-th input frame 22_n being the comparison target frame is smaller than the number of pixels of the n-th estimated frame 24_n, the number of pixels of the n-th input frame 22_n may be increased. Consequently, with the n-th estimated frame 24_n and the n-th input frame 22_n being arranged to have the same number of pixels, these frames can be compared. Note that when the numbers of pixels of the estimated frame 24 and the comparison target frame are the same, processing by the pixel count adjustment unit 103 need not be performed.

### Motion Compensation Application Unit

The motion compensation application unit 104 applies motion compensation to the comparison target frame, based on the motion information generated in the image processing system 1. Application of motion compensation by the motion compensation application unit 104 may be performed when the times (frame numbers) of the estimated frame 24 and the comparison target frame are different. For example, when the (n−1)-th estimated frame 24_n−1 is used as the comparison target frame, motion compensation may be applied to the (n−1)-th estimated frame 24_n−1, based on the motion information. Consequently, the n-th estimated frame 24 n and the (n−1)-th estimated frame 24_n−1 can be compared. Note that, when the comparison target frame has the frame at the same time as the n-th estimated frame 24_n, processing by the motion compensation application unit 104 need not be performed.

### Detection Unit

The detection unit 105 detects a difference related to the pixel information of the n-th estimated frame with respect to the comparison target frame, based on the n-th estimated frame 24_n and the comparison target frame. For example, by calculating a so-called SSIM (structural similarity) value related to a structural similarity index, the detection unit 105 may detect a difference related to the pixel information of the n-th estimated frame 24_n with respect to the comparison target frame.

The detection unit 105 may calculate each of the SSIM value of the entire frame and the SSIM value of each pixel. The detection unit 105 may determine whether the entire screen is changed, based on the SSIM value of the entire frame. When the detection unit 105 determines that the entire screen is changed, the detection unit 105 may determine that no defective image has occurred. Consequently, a scene change and the like in a video can be excluded from detection of a defective image.

### Defect Candidate Region Identification Unit

The defect candidate region identification unit 106 identifies and acquires a defect candidate region in the n-th estimated frame 24_n, based on the difference related to the pixel information detected by the detection unit 105. The defect candidate region identification unit 106 may identify a region in which the difference related to the pixel information is locally large as the defect candidate region. Note that the defect candidate region may be a region including at least one pixel or more. The defect candidate region may be acquired as a label, which is obtained by binarizing the SSIM value in the defect candidate region through threshold processing, and performing dilation and erosion processing and then labeling processing.

### Spatial Frequency Acquisition Unit

The spatial frequency acquisition unit 107 acquires a spatial frequency in the defect candidate region. The spatial frequency acquisition unit 107 may calculate and acquire the spatial frequency in the defect candidate region by performing calculation using fast Fourier transform, for example.

### Determination Unit

The determination unit 108 determines whether an image defect is present in the n-th estimated frame 24_n. Specifically, when the area of the defect candidate region (i.e., the number of pixels of the defect candidate region) is equal to or larger than a predetermined threshold, the determination unit 108 determines that an image defect is present in the n-th estimated frame 24 n. On the other hand, when the number of pixels of the defect candidate region is smaller than the predetermined threshold, the determination unit 108 determines that no image defect is present in the n-th estimated frame 24_n.

Here, the predetermined threshold may be a value weighted according to the spatial frequency in the defect candidate region. An image has a tendency that an image defect is more liable to occur in a region having a higher spatial frequency. Thus, the predetermined threshold may be reduced as the spatial frequency in the defect candidate region is higher. In this manner, by adjusting sensitivity related to the determination as to whether an image defect is present in accordance with the spatial frequency in the defect candidate region, excessive detection of the image defect can be reduced, and detection failures can be reduced.

### Image Defect Information Acquisition Unit

When the determination unit 108 determines that an image defect is present in the estimated frame 24, the image defect information acquisition unit 109 acquires image defect information. As illustrated in FIG. 7, the image defect information is information including the area (number of pixels), coordinates, time (frame number), an image, and the like that are related to the region including the image defect. The image related to the region including the image defect may be an image obtained by extracting only the region including the image defect from the estimated frame 24.

### Display Control Unit

The display control unit 110 displays the n-th estimated frame on the display unit 18 so that the region including the image defect is visually distinguishable from other regions. For example, as illustrated in FIG. 7, the display control unit 110 may display a broken line surrounding the region including the image defect on the display unit 18. Consequently, a person who conducts inspection of the image defect can visually recognize a location in which the image defect occurs.

Alternatively, for example, the display control unit 110 may display a circular shape surrounding the region including the image defect, or display an arrow pointing to the region including the image defect. The displayed circular shape or arrow may be expressed in a color that is easily visually recognizable (for example, red).

The display control unit 110 may display the image defect information acquired by the image defect information acquisition unit 109 on the display unit 18 or the like in the form of a list as illustrated in the table in FIG. 7. Consequently, a person who conducts inspection of the image defect can visually recognize the image defect information.

### 5. Processing Executed in Image Processing System

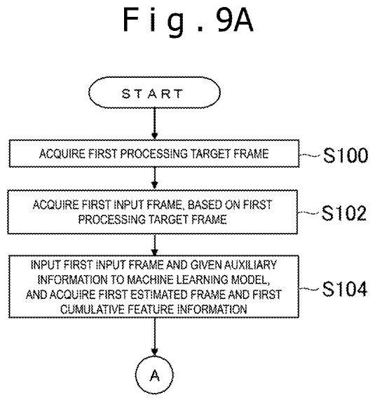

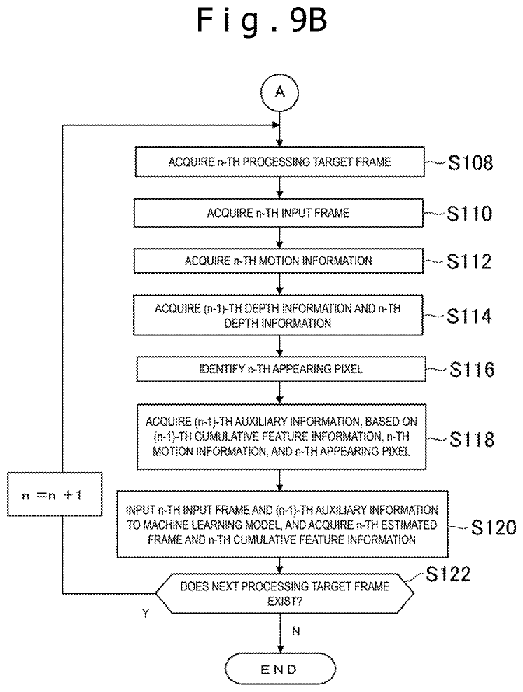

FIGS. 9A and 9B are flowcharts illustrating examples of flows of processing executed in the image processing system 1. The processing illustrated in FIGS. 9A and 9B is executed when the control unit 10 operates in accordance with the program stored in the storage unit 12.

(1) Processing When n=1

First, the control unit 10 acquires the first processing target frame 20_1 (S100). The control unit 10 acquires the first input frame 22_1, based on the first processing target frame 20_1 (S102). Furthermore, the control unit 10 inputs the input frame 22_1 and the given auxiliary information to the machine learning model 200, and acquires the first estimated frame 24_1 and the first cumulative feature information 26_1 (S104).

### (2) Processing When n≥2

The control unit 10 acquires the n-th processing target frame 20_n (S108). The control unit 10 acquires the n-th input frame 22_n, based on the n-th processing target frame 20_n (S110).

Subsequently, the control unit 10 acquires the (n−1)-th motion information (S112). The control unit 10 acquires the (n−1)-th depth information and the n-th depth information (S114), and identifies the n-th appearing pixel, based on the (n−1)-th depth information and the n-th depth information (S116). The control unit 10 acquires the (n−1)-th auxiliary information 28_n−1, based on the (n−1)-th cumulative feature information 26_n−1, the (n−1)-th motion information, and the n-th appearing pixel (S118).

Then, the control unit 10 inputs the n-th input frame 22_n and the (n−1)-th auxiliary information 28_n−1 to the machine learning model 200, and acquires the n-th estimated frame 24 n and the n-th cumulative feature information 26_n (S120).

The control unit 10 determines whether a next frame exists (S122), and when the control unit 10 determines that a next frame exists (S122; Y), the control unit 10 increments to n=n+1, and repeats the processing of S108 to S120. When the control unit 10 determines that a next frame does not exist (S122; N), the control unit 10 ends the processing.

### 6. Processing Executed in Image Defect Detector

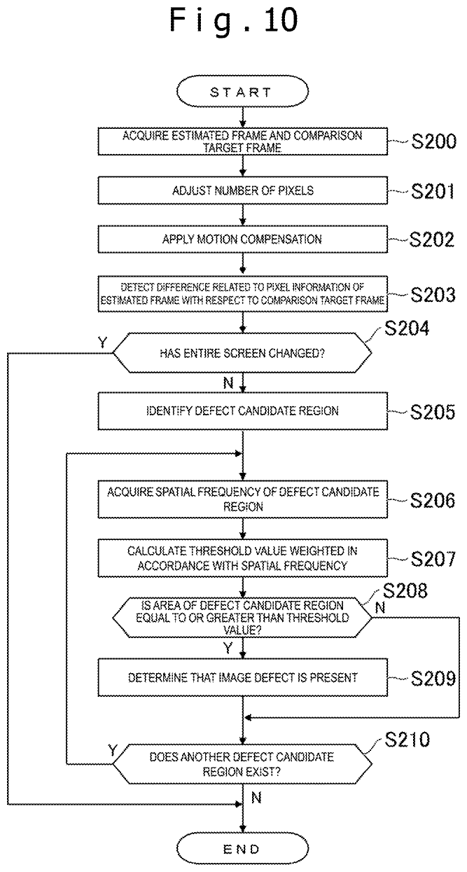

FIG. 10 is a flowchart illustrating an example of a flow of processing executed in the image defect detector 100. The processing illustrated in FIG. 10 is executed when the control unit 10 operates according to the program stored in the storage unit 12.

First, the control unit 10 acquires each of the estimated frame 24 and the comparison target frame (S200). Next, the control unit 10 adjusts the number of pixels of the comparison target frame (S201). Note that when the number of pixels of the estimated frame and the number of pixels of the comparison target frame are the same from the beginning, the processing of S201 may be omitted. The control unit 10 applies motion compensation to the comparison target frame (S202). The motion compensation may be performed based on the motion information acquired by the motion information acquisition unit 418. Note that, when the estimated frame 24 and the comparison target frame have the same time (frame number), the processing of S202 may be omitted.

Next, the control unit 10 detects a difference related to the pixel information of the estimated frame 24 with respect to the comparison target frame, based on the estimated frame 24 and the comparison target frame (S203). The control unit 10 determines similarity of the entire screen based on the difference related to the pixel information, and when the similarity of the entire screen is low, i.e., the entire screen is changed (S204; Y), the control unit 10 ends image defect detection processing related to the estimated frame 24.

The control unit 10 determines similarity of the entire screen based on the difference related to the pixel information, and when the similarity of the entire screen is high, i.e., the entire screen is not changed (S204; N), the control unit 10 identifies a region in which the difference related to the pixel information is locally large as the defect candidate region (S205).

Furthermore, the control unit 10 calculates and acquires a spatial frequency of the defect candidate region (S206). The control unit 10 calculates a threshold weighted according to the acquired spatial frequency (S207). When the area (number of pixels) of the defect candidate region is equal to or larger than the threshold calculated in S207, the control unit 10 determines that an image defect is present (S209), and acquires the image defect information. When another defect candidate region exists (S210; Y), the control unit 10 repeats the processing of S206 to S209. When another defect candidate region does not exist (S210; N), the control unit 10 ends the image defect detection processing. On the other hand, in S208, when the area (number of pixels) of the defect candidate region is smaller than the threshold calculated in S207 (S208; N), the processing proceeds to S210, and the control unit 10 determines whether no other defect candidate region exists.

Note that, although only the image defect detection processing for one estimated frame 24 is described in FIG. 10, the processing illustrated in FIG. 10 may be performed for each of the first to n-th estimated frames 24.

### 7. Summary

In the image processing system 1 according to the present embodiment described above, the n-th estimated frame 24_n is estimated by using the (n−1)-th cumulative feature information 26_n−1 indicating the features of the first to (n−1)-th input frames 22. In other words, information of the first to (n−1)-th input frames 22 can be used for estimation in addition to information of the n-th input frame 22_n, and thus information available for estimation increases, and the estimated frame 24_n having high image quality can be obtained.

In the image defect detector 100 being the image inspection system according to the present embodiment, an image defect in the estimated frame 24 can be easily checked. This can reduce human labor and check failures in checking the occurrence of an image defect. By using the input frame 22 or a past estimated frame 24 as a comparison target for determining whether an image defect has occurred, a frame as a comparison target need not be separately prepared. Note that, for example, the training estimated frame may be used as the comparison target frame.

The invention according to the present disclosure is not limited to the embodiment described above. For example, although the present embodiment illustrates a case in which the number of input pixels is greater than the number of initial pixels and the number of input pixels and the number of estimated pixels are equal numbers, the number of input pixels and the number of initial pixels may be equal numbers and the number of estimated pixels may be greater than the number of input pixels. In other words, the input frame 22 need not necessarily be obtained by enlarging the processing target frame 20.

### 8. Supplementary Notes

For example, the image inspection system may have the following configurations.
(1)

An image inspection system including at least one processor, wherein
the at least one processor:
acquires an n-th (where n is a natural number of 2 or greater) estimated frame output from a machine learning model by an n-th input frame and (n−1)-th auxiliary information related to features of first to (n−1)-th input frames being input to the machine learning model;
acquires a predetermined comparison target frame;
detects a difference related to pixel information of the n-th estimated frame with respect to the comparison target frame, based on the n-th estimated frame and the comparison target frame; and
acquires image defect information of the n-th estimated frame, based on the difference related to the pixel information.
(2)

The image inspection system according to (1), wherein
the at least one processor:
acquires a defect candidate region in the n-th estimated frame, based on the difference related to the pixel information;
determines whether an image defect is present in the n-th estimated frame, based on the number of pixels of the defect candidate region; and
acquires the image defect information, when determining that the pixel defect is present.
(3)

The image inspection system according to (2), wherein
the at least one processor determines that the image defect is present in the n-th estimated frame, when the number of pixels of the defect candidate region is equal to or greater than a predetermined threshold.
(4)

The image inspection system according to (3), wherein
the at least one processor acquires a spatial frequency in the defect candidate region, and
the threshold is a value weighted in accordance with the spatial frequency.
(5)

The image inspection system according to any one of (1) to (4), wherein
the at least one processor displays the n-th estimated frame on a display unit so that a region including the image defect is visually distinguishable from other regions.
(6)

The image inspection system according to any one of (1) to (5), wherein
the comparison target frame is the n-th input frame.
(7)

The image inspection system according to any one of (1) to (6), wherein
the at least one processor:
acquires (n−1)-th motion information being information indicating an amount and a direction of motion from the (n−1)-th input frame to the n-th input frame; and
acquires the comparison target frame by applying motion compensation to an (n−1)-th estimated frame, based on the (n−1)-th motion information.
(8)

The image inspection system according to any one of (1) to (6), wherein
the machine learning model is trained using a plurality of pieces of training data including a training input frame and a training estimated frame, and
the comparison target frame is the training estimated frame.

1. An image inspection system comprising:
one or more processors; and
one or more memories storing executable instructions thereon that, upon execution by the one or more processors, cause the image inspection system to at least
acquire an n-th estimated frame output from a machine learning model, the n-th estimated frame being generated by the machine learning model by inputting an n-th input frame and (n−1)-th auxiliary information related to features of first to (n−1)-th input frames into the machine learning model;
acquire a predetermined comparison target frame;
detect a difference related to pixel information of the n-th estimated frame with respect to the predetermined comparison target frame, based on the n-th estimated frame and the predetermined comparison target frame; and
acquire image defect information of the n-th estimated frame, based on the difference related to the pixel information,
wherein n is a natural number greater than 1.

2. The image inspection system of claim 1, wherein the executable instructions further cause the image inspection system to
acquire a defect candidate region in the n-th estimated frame, based on the difference related to the pixel information;
determine presence of an image defect in the n-th estimated frame, based on a number of pixels of the defect candidate region; and
acquire the image defect information, upon a determination of the presence of the image defect.

3. The image inspection system of claim 2, wherein determining the presence of the image defect in the n-th estimated frame comprises determining the number of pixels of the defect candidate region is equal to or greater than a predetermined threshold.

4. The image inspection system of claim 3, wherein the executable instructions further cause the image inspection system to:
acquire a spatial frequency in the defect candidate region, and
the predetermined threshold is a value weighted in accordance with the spatial frequency.

5. The image inspection system according to claim 1, wherein the executable instructions further cause the image inspection system to:
display the n-th estimated frame on a display unit such that a region including an image defect is visually distinguishable from other regions.

6. The image inspection system of claim 1, wherein
the predetermined comparison target frame is the n-th input frame.

7. The image inspection system of claim 1, wherein the executable instructions further cause the image inspection system to
acquire a (n−1)-th motion information indicating an amount and a direction of motion from the (n−1)-th input frame to the n-th input frame; and
acquire the predetermined comparison target frame by applying motion compensation to an (n−1)-th estimated frame, based on the (n−1)-th motion information.

8. The image inspection system of claim 1, wherein:
the machine learning model is trained using a plurality of pieces of training data including a training input frame and a training estimated frame, and
the predetermined comparison target frame is the training estimated frame.

9. An image inspection method comprising:
acquiring, by a processor, an n-th estimated frame output from a machine learning model, the n-th estimated model being generated by the machine learning model by inputting an n-th input frame and (n−1)-th auxiliary information related to features of first to (n−1)-th input frames into the machine learning model;
acquiring, by the processor, a predetermined comparison target frame;
detecting, by the processor, a difference related to pixel information of the n-th estimated frame with respect to the predetermined comparison target frame, based on the n-th estimated frame and the predetermined comparison target frame; and
acquiring, by the processor, image defect information of the n-th estimated frame, based on the difference related to the pixel information,
wherein n is a natural number greater than 1.

10. One or more computer readable storage media storing executable instructions that, upon execution by one or more processors, cause the one or more processors to at least:
acquire an n-th estimated frame output from a machine learning model, the n-th estimated frame being generated by the machine learning model by inputting an n-th input frame and (n−1)-th auxiliary information related to features of first to (n−1)-th input frames into the machine learning model;
acquire a predetermined comparison target frame;
detect a difference related to pixel information of the n-th estimated frame with respect to the predetermined comparison target frame, based on the n-th estimated frame and the predetermined comparison target frame; and
acquire image defect information of the n-th estimated frame, based on the difference related to the pixel information,
wherein n is a natural number greater than 1.
